(19) United States
(12) Patent Application Publication
(10) Pub. No.: US 2025/0337867 A1
(43) Pub. Date: Oct. 30, 2025

(54) ELECTRONIC DEVICE AND CONTROL METHOD THEREOF

(71) Applicant: SAMSUNG ELECTRONICS CO., LTD., Suwon-si (KR)

(72) Inventors: Andrii OMELCHENKO, Kyiv (UA); Illya DEGTYARENKO, Kyiv (UA); Veronika PROKHORCHUK, Kyiv (UA)

(73) Assignee: SAMSUNG ELECTRONICS CO., LTD., Suwon-si (KR)

(21) Appl. No.: 19/262,940

(22) Filed: Jul. 8, 2025

Related U.S. Application Data
(63) Continuation of application No. PCT/KR2025/005906, filed on Apr. 30, 2025.

(30) Foreign Application Priority Data
Apr. 30, 2004 (KR) 10-2024-0058021

(51) Int. Cl. H04N 9/31

(52) U.S. Cl. CPC H04N 9/3182; H04N 9/3185

(57) ABSTRACT

A control method of an electronic device includes: adding a first pattern to a source image to obtain a first image; projecting the first image onto a projection surface; acquiring a second image of the first pattern included in the projected first image; based on the first pattern included in the second image, identifying a pattern region distorted by an object in front of the projection surface; and changing a color or brightness of a portion of the source image that corresponds to the distorted pattern region.

### CROSS-REFERENCE TO RELATED APPLICATIONS

This application is a continuation application of International Application No. PCT/KR2025/005906 designating the United States, filed on Apr. 30, 2025, in the Korean Intellectual Property Receiving Office and claiming priority to Korean Patent Application No. 10-2024-0058021, filed on Apr. 30, 2024, the disclosures of which are all hereby incorporated by reference herein in their entireties.

### BACKGROUND

### 1. Technical Field

The present disclosure relates to an electronic device and a control method thereof, and more particularly, to an electronic device that does not project an image onto an object if the image is projected onto a projection surface obstructed by the object, and a control method thereof.

### 2. Background

An electronic device may include a device that projects an image onto a projection surface. The electronic device may project the image onto any of various projection surfaces such as a dedicated screen, an indoor or outdoor wall, a floor surface, and a ceiling, and is thus used in various ways.

Meanwhile, the image may be projected onto an object if the object, such as a person, is located in front of the projection surface. Accordingly, some parts of the image may be distorted, and the person may experience glare, or the like. Accordingly, there is an increasing need for technology to project the image by considering the object.

### SUMMARY

Aspects will be set forth in part in the description which follows and, in part, will be apparent from the description, or may be learned by practice of the presented embodiments.

According to an aspect of the disclosure, a control method of an electronic device may include: adding a first pattern to a source image to obtain a first image; projecting the first image onto a projection surface; acquiring a second image of the first pattern included in the projected first image; based on the first pattern included in the second image, identifying a pattern region distorted by an object in front of the projection surface; and changing a color or brightness of a portion of the source image that corresponds to the distorted pattern region.

The method may further include predicting a pose change of the object based on a change of the pattern region distorted by the object, where the changing the color or brightness includes changing the color or brightness of a portion of the source image that corresponds to the predicted pose change.

The method may further include: extracting a specific region of the object from the second image; and predicting a position change of the specific region, where the changing the color or brightness includes changing the color or brightness of a region of the source image that corresponds to the position change of the specific region.

The projecting the first image onto the projection surface may include: based on an external projector projecting a third image, different from the first image, onto the projection surface, projecting the first image at a position that at least partially overlaps the third image.

The first image may include at least one first matching point, where the first image is projected at a position at which the at least one first matching point overlaps at least one second matching point included in the third image.

The changing the color or brightness includes: among a plurality of pixels corresponding to a plurality of values, changing a value of a pixel corresponding to the distorted pattern region based on the value being within a predetermined range.

The source image may include a plurality of frames, where the adding the first pattern to the source image includes: replacing at least one frame among the plurality of frames with a frame that includes the first pattern.

The first pattern may include a plurality of patterns among: a plurality of horizontal lines, a plurality of vertical lines, a plurality of diagonal lines, or a plurality of lines at different angles, where the adding the first pattern to the first image includes: adding the plurality of patterns to the first image in sequence.

According to an aspect of the disclosure, an electronic device may include: a projector; at least one memory storing instructions, and information about a first pattern; and at least one processor configured to execute the instructions to: add the first pattern to a source image to obtain a first image, control the projector to project the first image onto a projection surface, acquire a second image of the first pattern included in the projected first image, based on the first pattern included in the second image, identify a pattern region distorted by an object in front of the projection surface, and control the projector to change a color or brightness of a portion of the source image that corresponds to the distorted pattern region.

The at least one processor may be further configured to execute the instructions to: predict a pose change of the object based on a change of the pattern region distorted by the object, and control the projector to change the color or brightness of a portion of the source image that corresponds to the predicted pose change.

The at least one processor may be further configured to execute the instructions to: extract a specific region of the object from the second image, predict a position change of the specific region, and control the projector to change the color or brightness of a region of the source image that corresponds to the position change of the specific region.

The at least one processor may be further configured to control the projector to: based on an external projector projecting a third image, different from the first image, onto the projection surface, project the first image at a position that at least partially overlaps the third image.

The first image may include at least one first matching point, where the at least one processor is further configured to execute the instructions to: control the projector to project the first image at a position at which the at least one first matching point overlaps at least one second matching point included in the third image.

The at least one processor may be further configured to execute the instructions to: among a plurality of pixels corresponding to a plurality of values, change a value of a pixel corresponding to the distorted pattern region based on the value being within a predetermined range.

According to an aspect of the disclosure, a non-transitory computer-readable recording medium storing a program which, when executed, causes at least one processor to perform a control method of an electronic device, where the method may include: adding a first pattern to a source image to obtain a first image; projecting the first image onto a projection surface; acquiring a second image of the first pattern included in the projected first image; based on the first pattern included in the second image, identifying a pattern region distorted by an object in front of the projection surface; and changing a color or brightness of a portion of the source image that corresponds to the distorted pattern region.

According to an aspect of the disclosure, a control method of an electronic device may include: obtaining a source image to be projected; projecting a first pattern onto a projection surface; acquiring a second image of the projected first pattern; based on the first pattern included in the second image, identifying a pattern region distorted by an object in front of the projection surface; and projecting the source image and the first pattern onto the projection surface, excluding a portion of the source image that corresponds to the distorted pattern region.

The control method may further include: adding the first pattern to the source image to obtain a first image, where the projecting the source image and the first pattern includes: projecting the first image onto the projection surface, and changing a color or brightness of a portion of the source image that corresponds to the distorted pattern region.

The source image may include a plurality of frames, where the adding the first pattern to the source image includes: replacing at least one frame among the plurality of frames with a frame that includes the first pattern.

The control method may further include predicting a pose change of the object based on a change of the pattern region distorted by the object, where the projecting the source image and the first pattern includes: projecting the source image and the first pattern onto the projection surface, excluding a portion of the source image that corresponds to the predicted pose change.

The control method may further include: extracting a specific region of the object from the second image; and predicting a position change of the specific region, where the projecting the source image and the first pattern includes: projecting the source image and the first pattern onto the projection surface, excluding a portion of the source image that corresponds to the position change of the specific region.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 and FIG. 2 are diagrams for describing an operation of a projector according to one or more embodiments of the present disclosure;

FIG. 3 is a block diagram for describing a configuration of the projector according to an embodiment of the present disclosure;

FIG. 4 is a flowchart for describing a control method of a projector according to an embodiment of the present disclosure;

FIG. 5 is a diagram for describing an example of a pattern used in the projector according to an embodiment of the present disclosure;

FIG. 6 is a diagram for describing a method of the projector for adding a first pattern to a first image according to an embodiment of the present disclosure;

FIG. 7 is a diagram for describing a method of the projector for sequentially changing and adding a plurality of patterns to the first image according to an embodiment of the present disclosure;

FIG. 8, FIG. 9, and FIG. 10 are diagrams for describing the first pattern extracted from a second image according to one or more embodiments of the present disclosure;

FIG. 11 is a diagram for describing a method of the projector for projecting the remaining image of the first image, excluding its portion corresponding to a distorted pattern region, onto the projection surface according to an embodiment of the present disclosure;

FIG. 12 is a diagram for describing a wide screen according to an embodiment of the present disclosure;

FIG. 13 and FIG. 14 are diagrams for describing a method of the projector or an external projector for adding a matching point to the image according to one or more embodiments of the present disclosure;

FIG. 15 is a diagram for describing a method of the projector in conjunction with the external projector for projecting the wide screen according to an embodiment of the present disclosure;

FIG. 16 and FIG. 17 are diagrams for describing a problem where the image is not projected into a shadowed region caused by an object if the projector projects the image according to one or more embodiments of the present disclosure;

FIG. 18 and FIG. 19 are diagrams for describing a problem where the image is not projected into the shadowed region caused by the object if the external projector projects the image according to one or more embodiments of the present disclosure; and

FIG. 20, FIG. 21 and FIG. 22 are diagrams for describing a method of an electronic device and an external projector in conjunction with each other for projecting the image without any shadowed region according to one or more embodiments of the present disclosure.

### DETAILED DESCRIPTION

The present disclosure may be variously modified and have several embodiments, and example embodiments of the present disclosure are thus shown in the drawings and described in detail in the detailed description. However, it should be understood that the scope of the present disclosure is not limited to the example embodiments, and include various modifications, equivalents, and/or alternatives according to the embodiments of the present disclosure. Throughout the accompanying drawings, similar components are denoted by similar reference numerals.

In describing the present disclosure, detailed description may be omitted for known functions or configurations which may unnecessarily obstruct the gist of the present disclosure.

In addition, the following embodiments may be modified in several different forms, and the scope and spirit of the present disclosure are not limited to the following embodiments. Rather, these embodiments are provided to make the present disclosure thorough and complete, and describe the spirit of the present disclosure to those skilled in the art.

Terms used in the present disclosure are used only to describe the specific embodiments rather than limiting the scope of the present disclosure. A term of a singular number may include its plural number unless explicitly indicated otherwise in the context.

In the present disclosure, an expression “have”, “may have”, “include”, “may include”, “comprise”, “may comprise”, or the like, indicates the presence of corresponding features (for example, a numerical value, a function, an operation, or a component such as a part), but does not exclude the presence of additional features.

In the present disclosure, an expression “A or B”, “at least one of A and/or B”, “one or more of A and/or B”, or the like, may include all possible combinations of one or more of the listed items. For example, “A or B”, “at least one of A and B” or “at least one of A or B” may indicate all of 1) a case where at least one A is included, 2) a case where at least one B is included, or 3) a case where both of at least one A and at least one B are included.

Expressions “first”, “second”, and the like used in the present disclosure, may indicate various components, regardless of the sequence and/or importance of the components. These expressions are used only to distinguish one component and another component from each other, and do not limit the corresponding components.

If any component (for example, a first component) is mentioned to be “(operatively or communicatively) coupled with/to” or “connected to” another component (for example, a second component), it should be understood that any component is directly coupled to another component or may be coupled to another component through still another component (for example, a third component).

On the other hand, if any component (for example, the first component) is mentioned to be “directly coupled” or “directly connected to” another component (for example, the second component), it should be understood that still another component (for example, the third component) is not present between any component and another component.

The expression “configured (or set) to” used in the present disclosure may be replaced with an expression “suitable for”, “having the capacity to”, “designed to”, “adapted to”, “made to” or “capable of”, for example, based on a situation. A term “configured (or set) to” may not necessarily mean “specifically designed to” in hardware.

Rather, an expression “a device configured to” in some contexts may indicate that the device may “perform˜” together with another device or component. For example, “a processor configured (or set) to perform A, B and C” may indicate a dedicated processor (for example, an embedded processor) that performs a corresponding operation or a generic-purpose processor (for example, a central processing unit (CPU) or an application processor) that performs the corresponding operation by executing at least one software program stored in a memory device.

In the embodiments, a “module” or a term ending with “˜er/or” may perform at least one function or operation, and be implemented by hardware, software, or a combination of hardware and software. In addition, a plurality of “modules” or a plurality of terms ending with “˜ers/ors” may be integrated in at least one module and implemented by at least one processor except for a “module” or term ending with “˜er/or” that needs to be implemented by specific hardware.

Meanwhile, the various elements and regions in the drawings are schematically shown. Therefore, the spirit of the present disclosure is not limited by relative sizes or intervals shown in the accompanying drawings.

Hereinafter, the embodiments of the present disclosure are described in detail with reference to the accompanying drawings so that those skilled in the art to which the present disclosure pertains may easily practice the present disclosure.

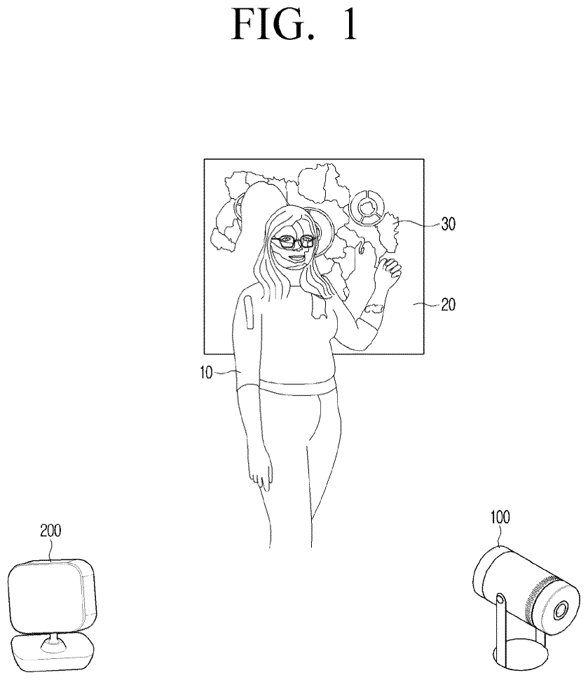

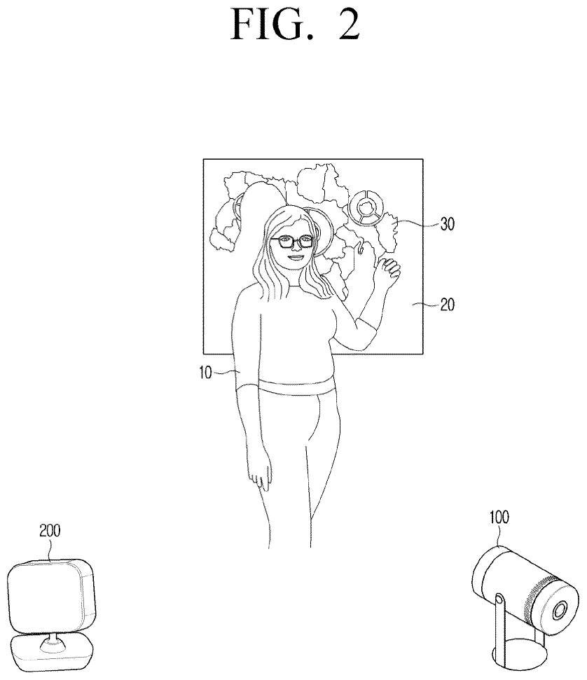

FIGS. 1 and 2 are diagrams for describing an operation of electronic device according to one or more embodiments of the present disclosure.

Referring to FIG. 1, the electronic device 100 may project a source image 30 onto a projection surface 20, in front of which an object 10 is disposed. In the present disclosure, the object 10 may be any living thing or object that may block light projected by the projector. For example, the object 10 may be a person, an animal such as a dog or a cat, a moving object such as a robot, or an object 10 disposed between the projection surface 20 and the electronic device 100. Hereinafter, the description is provided based on a case where the object 10 is a person.

If the object 10 is disposed in front of the projection surface 20, at least a portion of the image (hereinafter, the source image 30) projected by the electronic device 100 may be obstructed by the object 10, and a portion of the source image 30 may be projected onto the object 10 rather than onto the projection surface 20. The source image 30 may be a still image, such as an image, a photograph or text, or may be a video.

If the object 10 is a person, light projected by the electronic device 100 may interfere with a view of the object 10. In addition, even if an audience looks at the source image 30, a portion of the image projected onto the object 10 may be perceived as distorted.

To solve the problems mentioned above, according to various embodiments of the present disclosure, the electronic device 100 may add a predetermined pattern that is not perceptible to naked eyes of a person to the source image 30 to obtain a first image, and project the first image onto the projection surface 20.

The electronic device 100 may acquire an image (hereinafter, the second image) capturing the corresponding scene while the first image is projected onto the projection surface 20.

As an example, the second image may be provided from an external device if the external device including a camera is present and the electronic device 100 performs communication by being connected to the external device in a wired or wireless manner. FIGS. 1 and 2 show a case where the second image is captured by an external device 200 including the camera. The external device 200 may capture a scene in which the electronic device 100 projects the first image, which includes the predetermined pattern, onto the projection surface 20. Here, the external device 200 may be implemented as a device including the camera, such as the camera or a smartphone. The external device 200 may transmit the captured second image to the electronic device 100.

Although the example shown in FIGS. 1 and 2 illustrate the electronic device 100 and the camera 200 as separate components, the present disclosure is not limited thereto. For example, if the electronic device 100 includes the camera, the electronic device 100 may acquire the second image by using the camera.

The electronic device 100 may extract the pattern included in the first image from the acquired second image, and analyze the extracted pattern to thus identify a region where the object 10 is disposed in front of the projection surface 20. A form of the pattern and its extraction method are described in detail again in a section described below.

The electronic device 100 may project an image of the remaining region of the source image 30, excluding its portion corresponding to the region where the object 10 is disposed, onto the projection surface 20. Accordingly, as shown in FIG. 2, the source image 30 may not be projected onto the object 10, and only the remaining region of the first image 30 may be projected onto the projection surface 20.

The operations described with reference to FIGS. 1 and 2 may be performed by the projector having various configurations.

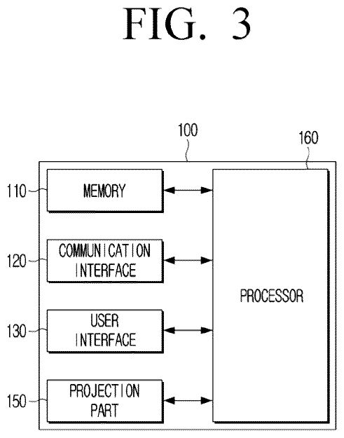

FIG. 3 is a block diagram for describing a configuration of the projector according to an embodiment of the present disclosure.

The electronic device 100 may include at least one of a memory 110, a communication interface 120, a user interface 130, a projection part 150 (e.g., a projector), or a processor 160.

The memory 110 may store at least one instruction regarding the electronic device 100. The memory 110 may store an operating system (O/S) for driving the electronic device 100. According to an embodiment, the memory 110 may store various software programs or applications for operating the electronic device 100 according to the various embodiments of the present disclosure. According to an embodiment, the memory 110 may include a semiconductor memory such as the flash memory 110, or a magnetic storing medium such as a hard disk.

The memory 110 may store various software modules for operating the processor 160 according to the various embodiments of the present disclosure, and the processor 160 may execute the various software modules stored in the memory 110 to control overall operations of the electronic device 100.

In the present disclosure, the term “memory 110” may be used to indicate the memory embedded in the electronic device 100, such as a read only memory (ROM) or a random access memory (RAM), and also be used to indicate a memory card (for example, a micro secure digital (SD) card or a memory stick) that is connected to the electronic device 100.

According to an embodiment of the present disclosure, the memory 110 may store information about the predetermined pattern to be added to the source image as well as the image to be projected (e.g., first image). The pattern may be an image to determine whether the object is present in front of the projection surface. For convenience of description, in the present disclosure, the pattern used by the electronic device 100 is referred to as the first pattern, and a pattern used by another projector (i.e., external projector) is referred to as a second pattern. The first pattern and the second pattern may be implemented as different patterns, but are not necessarily limited thereto. For example, the first pattern and the second pattern may be implemented as the same pattern. Detailed descriptions of a type of pattern, its addition method, or the like are provided below.

According to an embodiment of the present disclosure, the memory 110 may store information about at least one matching point to be added to the image. The matching point may be a reference point for naturally connecting the image with another image if one image is connected with another the image to thus provide one large image (e.g., wide screen). The matching point may be set to a specific coordinate within the image. Specific details of a method of projecting the wide screen by using the matching point are described below.

The communication interface 120 may be a component including circuitry and communicating with the external device and a server. The communication interface 120 may include at least one of a wired communication module or a wireless communication module. The wired communication module may be a component for performing the communication by being connected to various types of external devices in the wired manner.

The wired communication module may include various ports such as a universal serial bus (USB) port, a high definition multimedia interface (HDMI) port, a display port, a red-green-blue (RGB) port, a digital visual interface (DVI) port, a Thunderbolt, and a component port, and a processing circuit for processing a signal received through the port.

The wired communication module may be a component for performing the communication by being connected to various types of external devices in the wireless manner. The wired communication module may include at least one of a wireless-fidelity (Wi-Fi) communication module, a Bluetooth module, infrared communication (IrDA, or infrared data association) module, 3rd generation (3G) mobile communication module, 4th generation (4G) mobile communication module, 4th generation long term evolution (LTE) communication module, or 5th generation (5G) mobile communication module.

As described with reference to FIGS. 1 and 2, if the external device 200 including the camera is used, the processor 160 may communicate with the external device 200 through the wired communication module or the wireless communication module. The processor 160 may control the projection part 150 to project the first image, which includes the first pattern, and then control the communication interface 120 to transmit a capture signal to the external device 200. The external device 200 may perform the capture based on the received capture signal to thus acquire the second image, and then transmit data on the second image to the electronic device 100. The processor 160 may acquire the second image by receiving the data on the second image through the communication interface 120.

According to an embodiment of the present disclosure, the processor 160 may receive content data including the source image from an external source through the communication interface 120. The processor 160 may store the received content data in the memory 110. For example, if a web server providing a video on demand (VOD) service is connected to the electronic device 100 through the communication interface 120, the processor 160 may store content streaming or downloaded from the web server in the memory 110, and perform an image processing process such as demultiplexing to detect video data from the stored content, or decoding and scaling the detected video data, thereby generating the source image.

According to an embodiment of the present disclosure, the processor 160 may communicate with the external projector through the communication interface 120. In this case, the processor 160 in conjunction with the external projector may generate one large image by controlling the projection part 150 to project a partial image of one large image.

The user interface 130 is a component for receiving various user inputs. The user interface 130 may be implemented as a device such as a button, a touch pad, a mouse or a keyboard, or may be implemented as a touch screen or the like which may also perform a manipulation input function in addition to the above-described display function. Here, the button may be any of various types of buttons such as a mechanical button, a touch pad, or a wheel, which is disposed in any region of the electronic device 100, such as the front, side, or rear surface of its body.

If the processor 160 receives the user input for projecting the source image through the user interface 130, the processor 160 may control the projection part 150 to project the image based on the user input.

The processor 160 may selectively perform the operations described with reference to FIGS. 1 and 2 based on an operation mode set through the user interface 130. For example, if a user selects a first mode for projecting the source image regardless of the object, the processor 160 may control the projection part 150 to project the entire source image as described with reference to FIG. 1.

According to an embodiment, if the user selects the second mode for projecting only a region of the source image excluding the object, as described with reference to FIG. 2, the processor 160 may estimate a position of the object by using the first pattern, then exclude the corresponding portion, and output only the image of the remaining region.

In addition, the user interface 130 may receive any of the various user inputs, and the processor 160 may perform the corresponding operation.

According to an embodiment, user may input a user command by using a remote control. If the remote control is connected to the electronic device 100 in the Bluetooth or another wireless communication manner, the processor 160 may receive a remote control signal through the communication interface 120. In an embodiment, in the case of an infrared (IR) remote control, the processor 160 may receive the remote control signal through a separately provided IR reception circuit.

The projection part 150 may be referred to as a projector, and may be a component for projecting an image to the outside. The projection part 150 may be implemented in any of various projection methods (e.g., cathode-ray tube (CRT) method, liquid crystal display (LCD) method, digital light processing (DLP) method, or laser method).

The processor 160 may control the overall operations and functions of the electronic device 100. For example, the processor 160 may be connected to the configuration of the electronic device 100 that includes the memory 110, and execute at least one instruction stored in the memory 110 as described above, thereby controlling the overall operations of the electronic device 100.

The processor 160 may be implemented in various ways. For example, the processor 160 may be implemented as at least one of an application-specific integrated circuit (ASIC), a logic integrated circuit, an embedded processor, a microcontroller unit (Micom), a microprocessor, hardware control logic, a hardware finite state machine (FSM), or a digital signal processor (DSP).

In particular, the processor 160 may include at least one processor. At least one processor may include at least one of a central processing unit (CPU), a graphics processing unit (GPU), an accelerated processing unit (APU), a many integrated core (MIC), a digital signal processor (DSP), a neural processing unit (NPU), a main processing unit (MPU), a hardware accelerator, or a machine learning accelerator. At least one processor may control one of other components of the electronic device 100 or any combination thereof, and perform an operation related to the communication or data processing. At least one processor may perform a method according to the various embodiments of the present disclosure by executing at least one program or instruction stored in the memory.

The processor 160 may control the projection part 150 to project the remaining image of the source image, excluding its partial region, onto the projection surface. The processor 160 may mask a portion of the source image and provide data about the source image that includes the masked region to the projection part 150. As an example, the processor 160 may detect pixel coordinate values of a pixel region corresponding to a distorted pattern region of the first image. The processor 160 may change RGB values of pixels falling within a range of the detected coordinate values to black or other mono-colored pixel values. Accordingly, if the object 10 is a person, the person's glare may be prevented. The processor 160 may fixedly display the RGB values of the pixels falling within the range of the detected coordinate values regardless of an image frame included in the source image, and the present disclosure is not necessarily limited thereto. For example, if the image frame included in the source image is changed, the processor 160 may change the color or brightness of the masked region by considering the overall color or brightness of the image frame. For example, the masked region corresponding to the object 10 may be implemented in black if the image frame has dark color and brightness, and the masked region may be implemented in green, blue, or the like to minimize the glare of the object 10 while allowing a viewer to experience the presence of the object 10 if the image frame has bright color and brightness.

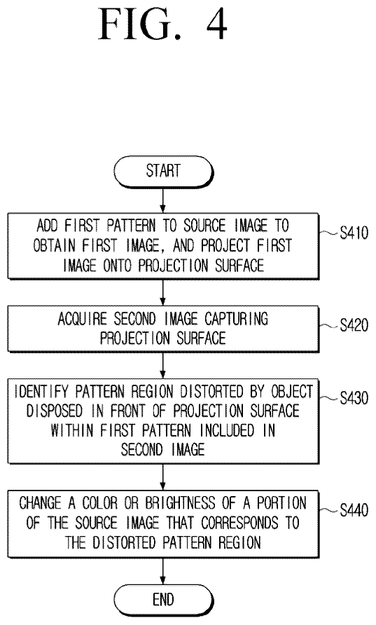

FIG. 4 is a flowchart for describing an operation of the projector according to an embodiment of the present disclosure. The operation shown in FIG. 4 may be performed by the electronic device 100 having the same configuration as FIG. 3, but the present disclosure is not necessarily limited thereto, and the corresponding operation may also be performed by the projector having a partially different configuration, having an additional configuration, or omitting some configurations. Hereinafter, the description is provided based on the projector having the configuration shown in FIG. 3.

Referring to FIG. 4, the processor 160 may add the first pattern to a source image to obtain a first image, and project the first image onto the projection surface (S410).

The processor 160 may acquire the data about the source image. The data about the source image may be the content data including the image or the video data detected from the content data. The processor 160 may receive the data about the source image from various content sources such as an external server, or load the data about the source image pre-stored in the memory 110.

The processor 160 may add the first pattern to the source image to obtain the first image if data to project the source image is acquired.

Information about the first pattern may be pre-stored in the memory 110. The first pattern may be implemented in various forms.

The first pattern may include at least one of a plurality of horizontal lines, a plurality of vertical lines, a plurality of diagonal lines, or a plurality of lines at different angles.

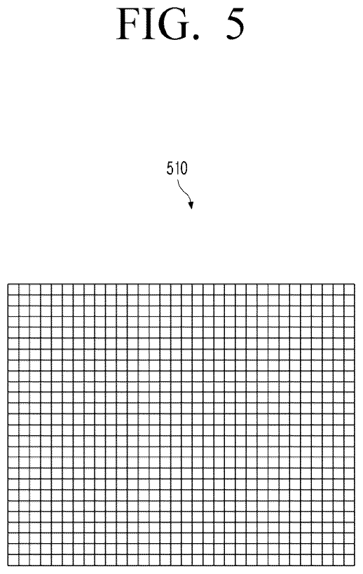

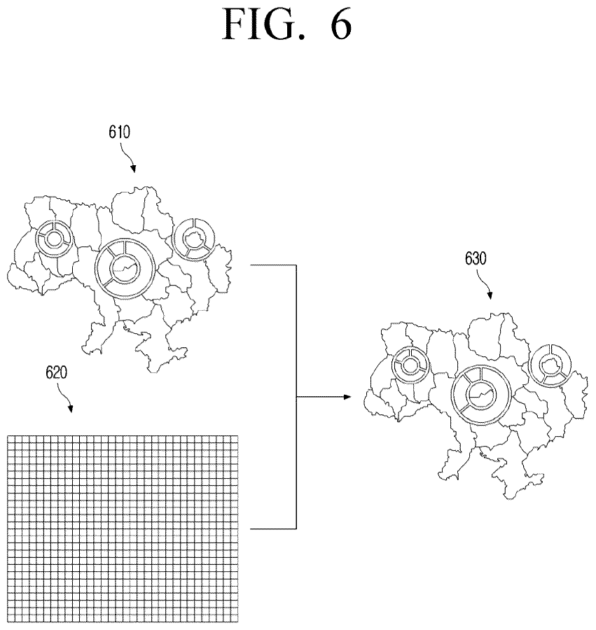

FIG. 5 is a diagram for describing an example of the pattern according to an embodiment of the present disclosure.

Referring to FIG. 5, a predetermined pattern 510 may be implemented as a pattern including the plurality of horizontal lines and the plurality of vertical lines, e.g., a grid pattern.

The processor 160 may add the first pattern to the source image to obtain the first image.

FIG. 6 is a diagram for describing a method of the projector for adding the first pattern to the source image according to an embodiment of the present disclosure.

Referring to FIG. 6, the processor 160 may add a first pattern 620 to a source image 610 to thus generate the first image 630 including the first pattern 620 and the source image 610. Here, the first pattern 620 added to the source image 610 may be an invisible pattern that is not detectable by the naked eyes of a person. As an example, the first pattern 620 may be a pattern encoded using a steganographic method. Accordingly, the first pattern 620 added to the source image 610 may not be detected by the naked eyes of the user, that is, the viewer.

The processor 160 may add the first pattern by changing the pixel value of the pixel disposed at a position corresponding to the first pattern in the source image.

For example, the processor 160 may combine the first pattern with the source image by using the steganographic method of changing a value of the least-significant bit (LSB) of data for expressing the RGB value of the pixel corresponding to the position of the first pattern among the pixels included in the source image.

If the source image includes the plurality of frames, the processor 160 may add the first pattern to at least one frame among the plurality of frames included in the source image. Accordingly, the processor 160 may replace at least one frame among the plurality of frames included in the source image with a frame combined with the first pattern.

For example, if the source image is output at 60 frames per second, the processor 160 may replace at least one frame out of every 60 frames among the plurality of frames included in the source image with the frame combined with the first pattern.

According to an embodiment, the processor 160 may insert at least one additional frame including the first pattern between the plurality of frames included in the source image. For example, the processor 160 may insert the additional frame including the first pattern into at least one frame out of every 60 frames among the plurality of frames included in the source image.

The additional frame may be inserted periodically or intermittently. For example, the source image may be a presentation file or a still image, in which case the electronic device 100 and the processor 160 may continuously project one frame until a user manipulation is input. The processor 160 may control the projection part 150 to project the additional frame including the first pattern at least once at an initial stage in which a projection command for the source image is input. The processor 160 may control the projection part 150 to briefly project the same frame to which the first pattern is added and then project an original frame from the source image again if one of the frames included in the source image is displayed for a certain period of time or more.

The processor 160 may acquire the second image captured by the external device 200 or the projector's own camera at a time point at which the frame including the first pattern is displayed, and determine which portion of the first pattern is distorted.

According to an embodiment of the present disclosure, the processor 160 may sequentially or alternately change the first pattern to one of the plurality of patterns.

For example, the memory 110 may store data on the plurality of patterns among the pattern including the plurality of horizontal lines, the pattern including the plurality of vertical lines, the pattern including the plurality of diagonal lines, and the pattern including the plurality of lines at the different angles.

Here, the processor 160 may select one of the plurality of patterns as the first pattern and add the selected first pattern to the source image. The processor 160 may then select another pattern as the first pattern and add another selected first pattern to the source image. In this way, the processor 160 may selectively use various different first patterns.

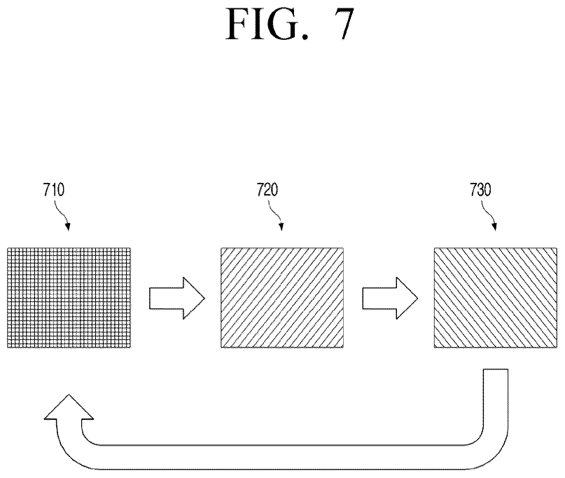

FIG. 7 is a diagram for describing a method of the projector for sequentially changing and adding the plurality of patterns to the source image according to an embodiment of the present disclosure.

Referring to FIG. 7, the processor 160 may select a pattern 710 including the plurality of horizontal lines and the plurality of vertical lines, a pattern 720 including a plurality of first diagonal lines, and a pattern 730 including a plurality of second diagonal lines as the first pattern and sequentially add these patterns to the source image. The processor 160 may then change the pattern in an order of the pattern 710 including the plurality of horizontal lines and vertical lines, the pattern 720 including the plurality of first diagonal lines, and the pattern 730 including the plurality of second diagonal lines. A type of pattern that shows whether the pattern is distorted may be changed based on the size or shape of the object. As described with reference to FIG. 7, the processor 160 may effectively extract the distorted portion within the first pattern as the plurality of patterns are sequentially or alternately are added to the source image and then projected as the first image. A detailed method of the processor 160 for extracting the first pattern is described below.

The first pattern described above may be used to detect the position of the object. However, according to an embodiment, the first pattern may further include additional information in addition to information used to detect the position of the object.

For example, the first pattern may include a watermark. The watermark may be used to indicate content that is restricted from access. The processor 160 may prevent unauthorized use of an image including the watermark by stopping or restricting its output.

According to an embodiment, the first pattern may include information on at least one of date, author, brand, or position.

According to an embodiment, the first pattern may include metadata of the source image. The metadata of the source image may include at least one of a title of the source image, a type of the source image, a compression method of the source image, or a resolution of the source image.

The processor 160 may acquire information or data included in the first pattern and store the same in the memory 110, separately from checking the distorted image of the first pattern by extracting the first pattern.

According to an embodiment of the present disclosure, the first pattern may be generated in a form corresponding to an environment in which the processor 160 projects the first image.

The first pattern may use a color that is easily identifiable from the projection surface onto which the processor 160 projects the first image. For example, if a wall is white, the first pattern may use a black color.

According to an embodiment, the first pattern may have a form that allows the first pattern to be easily identifiable from the projection surface onto which the processor 160 projects the first image. For example, if the wall includes the plurality of vertical lines, the first pattern may have a form that allows the first pattern to include the plurality of horizontal lines.

In the above-described embodiments, the processor 160 is described as adding the first pattern directly to the source image. However, the present disclosure is not limited thereto, and the processor 160 may also receive the first image already including the first pattern from the external source. Here, a method by which the first pattern is added to the first source may be the same as the method described above.

If the first pattern is added to the source image, the processor 160 may project the first image onto the projection surface. Here, the projection surface may have at least a portion obstructed by the object. For example, the object may be disposed in front of the projection surface. In the present disclosure, the object may be a person, and is not limited thereto. That is, the processor 160 may project the first image including the first pattern onto the projection surface having at least a portion obstructed by the object.

Referring back to FIG. 4, the processor 160 may acquire the second image capturing the projection surface if the first image is projected onto the projection surface while the object is disposed in front of the projection surface (S420). In a case such as that shown in FIG. 1 or 2, the processor 160 may receive the second image from the external device that captures the scene in which the first image is projected. According to an embodiment, the processor 160 may acquire the second image directly by capturing the scene in which the first image is projected onto the projection surface by using the camera included in the electronic device 100.

The processor 160 may identify the pattern region distorted by the object disposed in front of the projection surface within the first pattern included in the second image if the second image is acquired (S430).

As described above, the processor 160 may add the first pattern to the source image by using the method of changing the value of the least-significant bit of the RGB value of at least one pixel among the pixels included in the source image.

If the second image capturing the first image is acquired, the processor 160 may extract the pixel value of each pixel included in the second image. The processor 160 may identify the value of the least-significant bit of the RGB value of each pixel included in the first image, and extract the first pattern projected onto the projection surface by using the identified value of the least-significant bit.

The processor 160 may identify the pattern region distorted by the object disposed in front of the projection surface within the first pattern included in the second image if the first pattern is acquired.

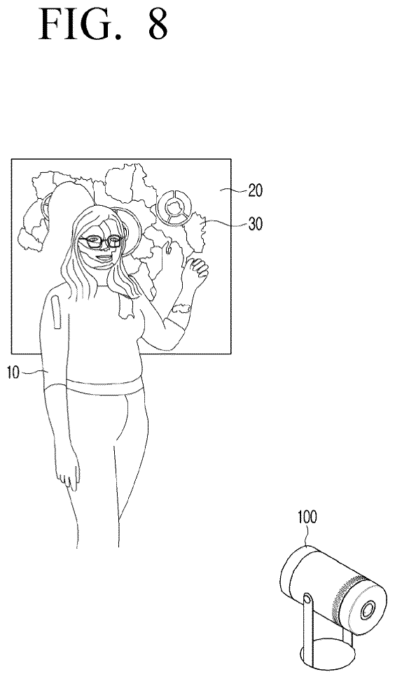

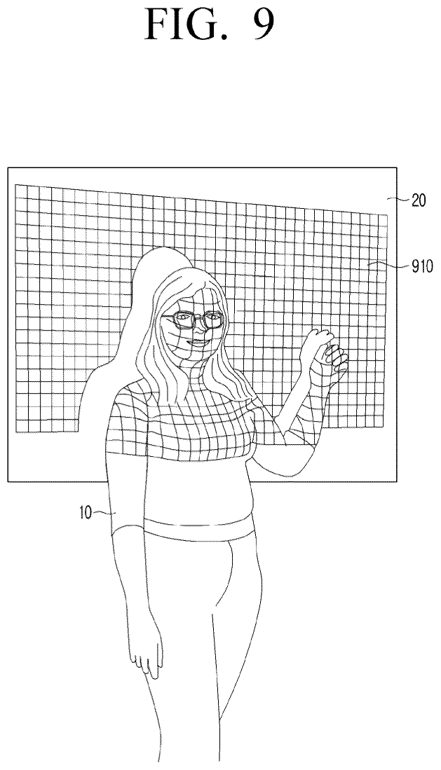

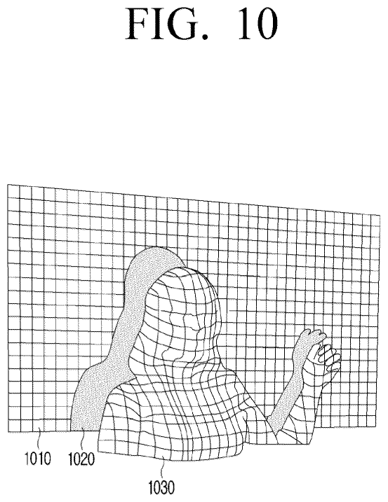

FIGS. 8, 9, and 10 are diagrams for describing the first pattern extracted from the second image according to an embodiment of the present disclosure.

Referring to FIG. 8, the processor 160 may acquire the second image capturing the scene in which the first image, which includes the first pattern, is projected onto the projection surface 20 in front of which the object 10 is disposed.

Referring to FIG. 9, the processor 160 may identify a first pattern 910 projected onto the projection surface 20 having the object 10 disposed in front thereof from the second image. The first pattern 910 shown in FIG. 9 may be a pattern identified through the image processing of the processor 160, rather than the pattern visible to the naked eyes of the person.

The processor 160 in the present disclosure may identify the plurality of regions included in the first pattern by using a pattern segmentation algorithm.

As described with reference to FIGS. 1 and 2, if the camera is embedded in the external device 200, a capture direction and a projection direction of the first image may be different from each other. Accordingly, the second image may include a shadowed region caused by the object in addition to the region where the object is exposed in the first image.

If the electronic device 100 includes its own camera, the projection direction of the first image which includes the first pattern and the capture direction thereof may be the same as each other, and the pattern may thus be distorted only in the portion where the object is exposed in the capture direction of the electronic device 100.

Referring to FIG. 10, the processor 160 may identify a region 1010 of the first pattern 910 included in the second image, in which the first pattern 910 is projected onto the projection surface, a shadowed region 1020 of the first pattern 910 that is caused by the object, and a region 1030 of the first pattern 910 that is distorted by the object.

Here, the shadowed region 1020 caused by the object 10 may indicate a region of the projection surface that is obstructed by the object and onto which the first pattern 910 (or the first image) is not projected.

The region 1030 distorted by the object 10 may indicate a region where the first pattern 910 (or the first image) is projected onto the object 10.

The processor 160 may identify a region where an interval between the lines included in the pattern is not constant or a portion displayed in a curved shape rather than a straight line as the distorted pattern region.

If the pattern region distorted by the object is identified within the first pattern included in the second image, the processor 160 may project the image of the remaining region of the source image, excluding a portion of the source image corresponding to the distorted pattern region, onto the projection surface.

The processor 160 may identify a portion of the source image that corresponds to the distorted pattern region of the first pattern included in the second image.

In addition, the processor 160 may project the remaining image of the source image, excluding its portion corresponding to the distorted pattern region, onto the projection surface.

The processor 160 may mask a portion of the source image that corresponds to the distorted pattern region not to project the portion corresponding to the distorted pattern region of the first image onto the projection surface.

According to an embodiment of the present disclosure, the processor 160 may implement the projection surface onto which the first image is projected and the position of the object as a three-dimensional (3D) map if the distorted pattern region is identified. The processor 160 may identify a portion of the source image that is projected onto the object if the projection surface, onto which the first image is projected, and the position of the object are implemented as the 3D map. The processor 160 may project the remaining image of the source image, excluding a portion projected onto the object, onto the projection surface if the portion of the source image that is projected onto the object is identified.

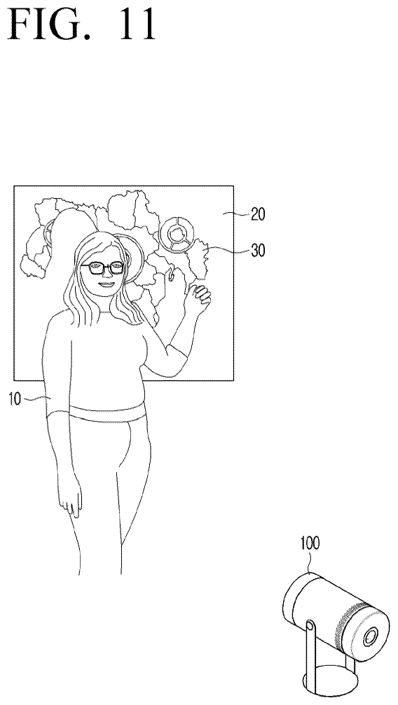

FIG. 11 is a diagram for describing a method of the projector for projecting the remaining image of the first image, excluding its portion corresponding to the distorted pattern region, onto the projection surface according to an embodiment of the present disclosure.

Referring to FIG. 11, if the pattern region distorted by the object is identified within the first pattern included in the second image, the processor 160 may project the remaining image of the source image 30, excluding the portion corresponding to the distorted pattern region, onto the projection surface 20.

Accordingly, the processor 160 may not project the source image onto the object 10 even if the object 10 is disposed in front of the projection surface 20.

A pose of the object may be changed continuously over time. The projector in the present disclosure may predict the pose change of the object and project the remaining region of the source image, excluding its region corresponding to the predicted pose change, onto the projection surface.

The processor 160 may identify the region distorted by the object, and identify the pose of the object.

If the pose of the object is identified, the processor 160 may predict the pose change of the object by using the identified pose of the object.

If the pose change of the object is predicted, the processor 160 may project the remaining image of the source image, excluding its region corresponding to the predicted pose change. The processor 160 may perform the plurality of consecutive captures by using the projector's own camera or the external device 200 to predict the pose change. The processor 160 may track position changes of pixels corresponding to the object within the plurality of frames acquired by the consecutive captures, thereby acquiring their feature vectors. For example, if positions of the pixels are determined to be moved to the right at a constant speed, the processor 160 may determine that the object is moved to the right.

According to an embodiment, the processor 160 may use an artificial intelligence model to predict the pose change of the object. In this case, the processor 160 may input the plurality of captured second images into the artificial intelligence model and estimate the pose change based on their output values.

According to an embodiment, if the object is a person, the processor 160 may identify a position of the person's major joint at a first time point. The processor 160 may input the position of the major joint and the second image into the artificial intelligence model to thus predict a position change of the major joint.

The artificial intelligence model may be a model trained to predict the pose change based on various captured images. The artificial intelligence model may be pre-stored in the memory 110.

If the position of the major joint is predicted, the processor 160 may predict the pose of the object that corresponds to the predicted position of the major joint. At a second time point after the first time point, the processor 160 may project the remaining image of the source image, excluding its portion corresponding to the predicted pose of the object.

If the entire pose of the object is predicted and the image is projected based on the predicted pose, resource consumption may be increased and the accuracy of pose prediction may be decreased.

Accordingly, the projector in an embodiment of the present disclosure may predict a pose of a specific part of the object and project the remaining region of the source image, excluding its region corresponding to the pose of the predicted part, onto the projection surface.

For example, the processor 160 may extract a face region of the object from the second image. In addition, the processor 160 may predict a position change of the face region.

The processor 160 may project the remaining portion of the source image as it is to the remaining region of the source image, excluding its region corresponding to the predicted position change of the face region.

Meanwhile, according to an embodiment of the present disclosure, the electronic device 100 in conjunction with the external projector may project one wide screen.

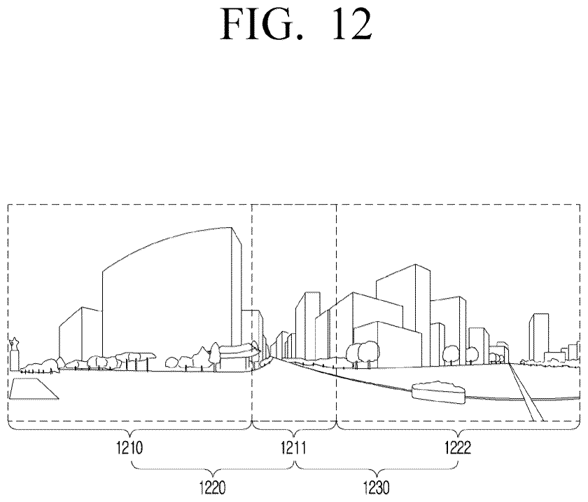

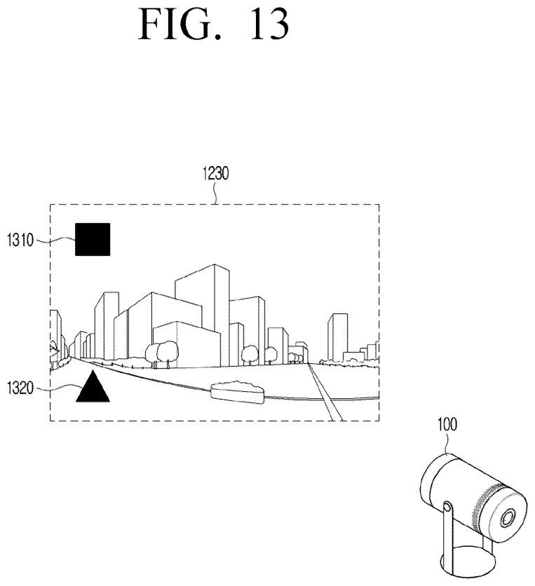

FIG. 12 is a diagram for describing the wide screen according to an embodiment of the present disclosure. For the convenience of description, the image projected by the electronic device 100 may be referred to as the first image, and an image projected by the external projector may be referred to as a third image.

Referring to FIG. 12, the wide screen may have a form in which a first image 1230 and a third image 1220 are merged. In this case, a part of the first image 1230 and a part of the third image 1220 may overlap each other to achieve their natural connection. In FIG. 12, the wide screen may be classified into a first part 1210, a second part 1211, and a third part 1222, where a second part 1211 may be a part where the first image 1230 and third image 1220 overlap each other.

In the present disclosure, “the wide screen” may be replaced with a term such as “large screen”, “panoramic screen”, or “extended screen”.

To project the first image onto a position where the first image is merged with the third image, the first image may include at least one first matching point, and the third image may include at least one second matching point.

In the present disclosure, “the matching point” may also be referred to as an expression such as “reference point”, “reference coordinate”, “reference mark”, or the like.

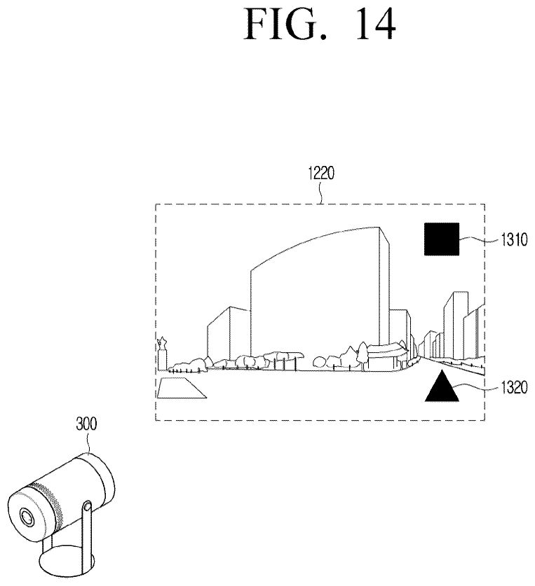

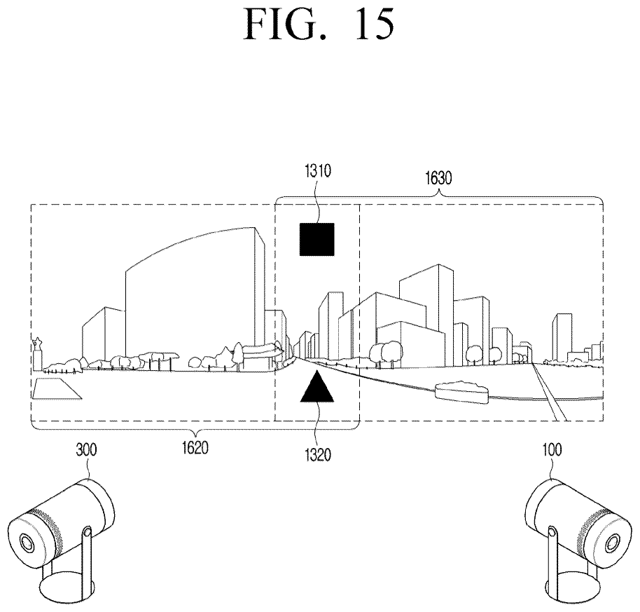

FIGS. 13 and 14 are diagrams for describing a method of the projector or the external projector for adding the matching point to the image according to an embodiment of the present disclosure.

Referring to FIG. 13, the processor 160 may add at least one first matching point 1310 or 1320 to the first image 1230. Here, a method of the processor 160 for adding at least one first matching point 1310 or 1320 to the first image 1230 may be the same as the method of the processor 160 for combining the predetermined first pattern into the source image. That is, at least one first matching point 1310 or 1320 may be added to the first image 1230 by using a method that is undetectable by the naked eyes of a person. In addition, the processor 160 may project the first image 1230, which includes the at least one matching point 1310 or 1320, onto the projection surface.

Referring to FIG. 14, an external projector 300 may combine at least one second matching point 1310 or 1320 into the third image 1220. Here, a method of the external projector 300 for combining at least one second matching point into the third image may be the same as the method of the processor 160 for combining the predetermined pattern into the source image. In addition, the external projector 300 may project the first image, to which at least one second matching point 1310 or 1320 is added, onto the projection surface.

At least one first matching point and at least one second matching point may have the same shape and size, and the present disclosure is not limited thereto.

At least one first matching point and at least one second matching point may be combined with each other at the same position of the second part of the wide screen.

The processor 160 may project the first image onto the position where the first image is merged with the third image if the external projector 300 projects the third image, which is different from the first image, onto the projection surface.

The first matching point and the second matching point may serve as reference points for combining the first image and the third image with each other. In addition, the processor 160 and the external projector 300 may project the wide screen together by using at least one matching point.

If the processor 160 includes a motor for adjusting the projection direction of the projection part 150, the processor 160 may analyze the second image to identify the positions of the first and second matching points, respectively, and then drive the motor to adjust the projection direction of the projection part 150 for the first matching point to be moved to the position of the second matching point. If the sizes of the first image and the third image are different from each other, an overall connection therebetween may be unnatural even if the images have one overlapping position between the matching points. The processor 160 may analyze the second image to compare the sizes of the first matching point and the second matching point, and if there is a size difference, the processor 160 may scale the size of the first image to match the sizes of the matching points.

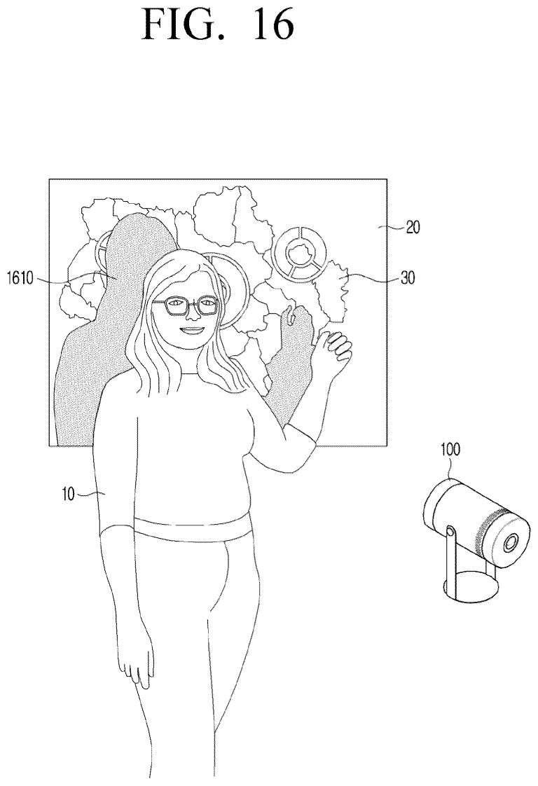

FIG. 15 is a diagram for describing a method of the projector in conjunction with the external projector for projecting the wide screen according to an embodiment of the present disclosure.

Referring to FIG. 15, the processor 160 may project the first image 1630, with at least one first matching point 1310 or 1320 included in the first image 1230 (e.g., first image 1230 shown in FIGS. 12 and 13) and at least one second matching point 1310 or 1320 included in the third image 1220 (e.g., third image shown in FIGS. 12 and 14) to be displayed on their overlapping position.

That is, the processor 160 may project the first image 1630 onto the projection surface, including at least one first matching point 1310 or 1320 combined into the first image 1230, and at least one second matching point 1310 or 1320 combined into the third image 1220. to be displayed on their overlapping position.

Similarly, the external projector 300 may project the third image 1620 onto the projection surface, including at least one second matching point 1310 or 1320 combined into the third image 1220, and at least one first matching point 1310 or 1320 combined into the first image 1230 to be displayed on their overlapping position.

Meanwhile, the first image may not be projected into the shadowed region caused by the object in addition to the region where the object is disposed in front of the projection surface.

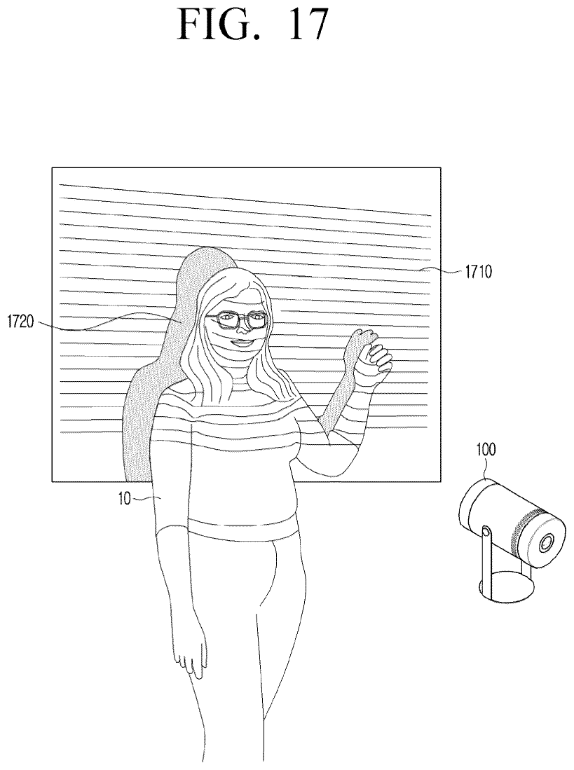

FIGS. 16 and 17 are diagrams for describing a problem where the image is not projected into the shadowed region caused by the object if the projector projects the image according to an embodiment of the present disclosure.

Referring to FIG. 16, if the processor 160 projects the first image 30 onto the projection surface 20, in front of which the object 10 is disposed, the source image 30 may not be projected into a first shadowed region 1610 caused by the object 10.

Here, the processor 160 may add the first pattern to the source image 30 to obtain the first image, and project the first image, which includes the first pattern, onto the projection surface. In addition, the processor 160 may acquire the image capturing the scene in which the first image, which includes the first pattern, is projected onto the projection surface.

In addition, the processor 160 may identify the first pattern projected onto the projection surface from the acquired image. Here, the first pattern may include the plurality of horizontal lines.

The second pattern projected onto the projection surface 20 may be as shown in FIG. 17.

Referring to FIG. 17, a first pattern 1710 projected onto the projection surface may include the region distorted by the object and a shadowed region 1720 caused by the object.

Here, the first image may not be projected onto the shadowed region 1720 caused by the object.

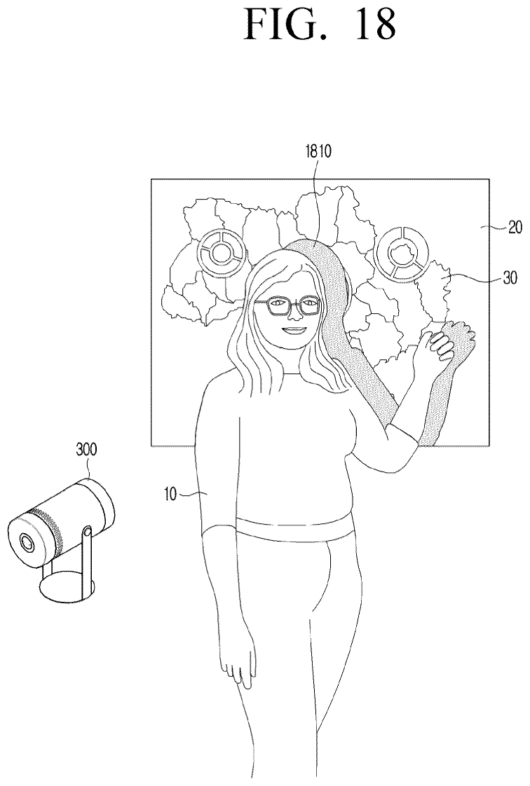

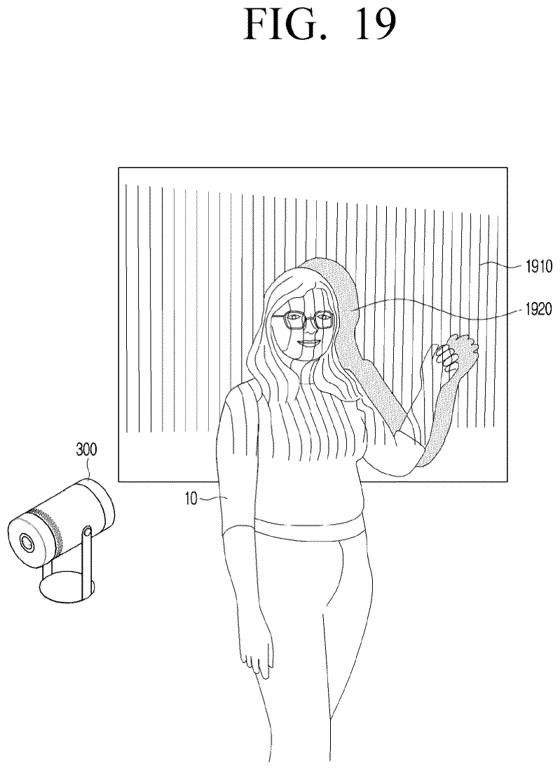

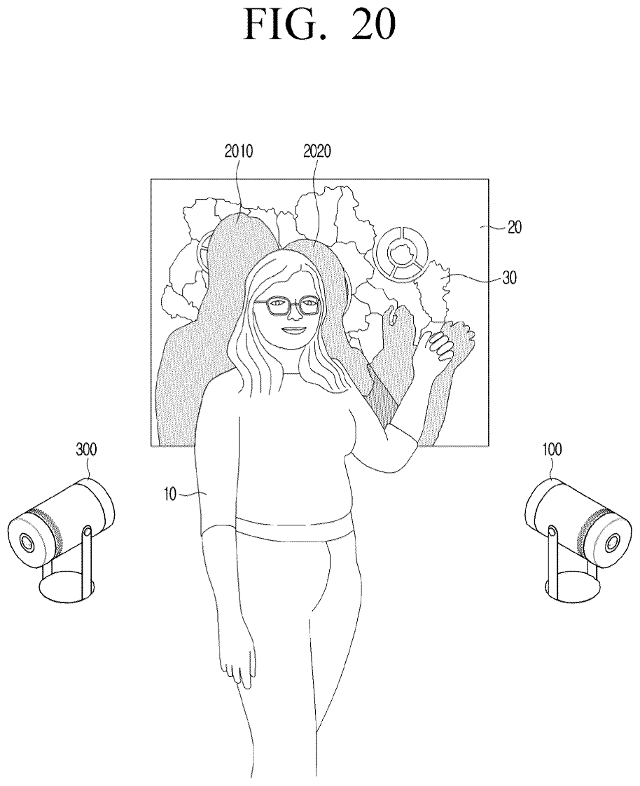

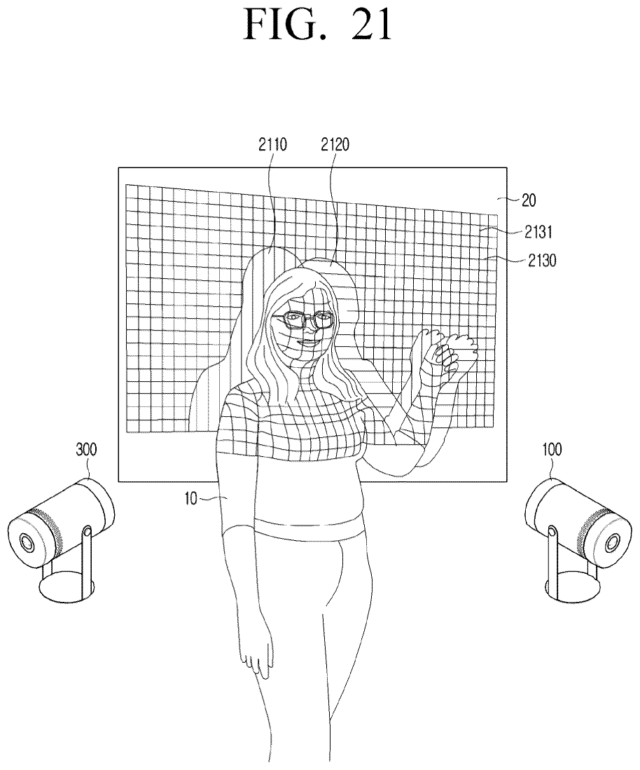

FIG. 18 and FIG. 19 are diagrams for describing a problem where the image is not projected into the shadowed region caused by the object if the external projector projects the image according to an embodiment of the present disclosure.

Referring to FIG. 18, the external projector 300 may project the source image 30 onto the projection surface 20, in front of which the object 10 is disposed, at a different position from the electronic device 100.

Here, the source image may not be projected onto a shadowed region 1810 caused by the object 10.

Here, the external projector 300 may add the second pattern to the source image 30 to obtain the first image, and project the first image which includes the second pattern, onto the projection surface 20. Here, the second pattern may include the plurality of vertical lines.

The second pattern projected onto the projection surface 20 may be as shown in FIG. 19.

Referring to FIG. 19, a second pattern 1910 projected onto the projection surface may include the region distorted by the object and a shadowed region 1920 caused by the object.

Here, the source image may not be projected onto the shadowed region 1920 caused by the object.

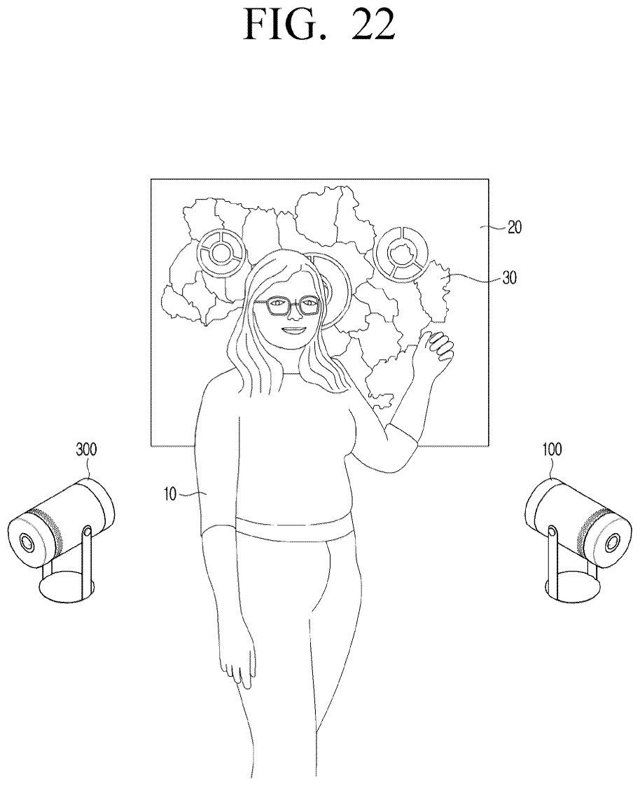

FIGS. 20, 21 and 22 are diagrams for describing a method of an electronic device and the external projector in conjunction with each other for projecting the first image without any shadowed region according to an embodiment of the present disclosure.

Referring to FIG. 20, the electronic device 100 and the external projector 300 may project the source image 30 onto the projection surface 20, in front of which the object 10 is disposed. Here, a first shadowed region 2010 and a second shadowed region 2020, caused by the object 10, may occur on the projection surface 20.

The first shadowed region 2010 may be a region where the source image projected by the electronic device 100 is not projected. The second shadowed region 2020 may be a region where the source image projected by the external projector 300 is not projected.

Here, the processor 160 may add the first pattern to the source image 30 to obtain the first image, and project the first image 30, which includes the first pattern, onto the projection surface.

In addition, the external projector 300 may add the second pattern to the source image 30 to obtain the first image, and project the first image, which includes the second pattern, onto the projection surface.

Here, the first pattern and/or the second pattern may be added to the source image 30 by using the method that is undetectable by the naked eyes of a person. The first pattern and the second pattern may be the same as the first pattern and the second pattern described with reference to FIGS. 17 and 19.

The processor 160 may acquire the image capturing the scene in which one of the first images, which includes the first pattern, and the other of the first images, which includes the second pattern, are projected.

In addition, the processor 160 may identify the predetermined pattern from the acquired image. Here, the identified predetermined pattern may include the first pattern and the second pattern.

The pattern identified by the processor 160 from the acquired image may be as shown in FIG. 21.

Referring to FIG. 21, the pattern identified by the processor 160 may include a first pattern 2130 and a second pattern 2131.

The processor 160 may classify the identified pattern into the plurality of regions.

Here, the plurality of regions included in the identified pattern may include a first shadowed region 2110 where the first pattern 2130 is not projected due to the object 10 and a second shadowed region 2120 where the second pattern 2131 is not projected due to the object 10.

The first shadowed region 2110 may indicate a region where the source image projected by the electronic device 100 is obstructed by the object 10 and is not projected onto the projection surface 20. In addition, the second shadowed region 2120 may indicate a region where the source image projected by the external projector 300 is obstructed by the object 10 and is not projected onto the projection surface 20.

Here, the processor 160 may identify a region where the first pattern 2130 is not projected and the second pattern is projected as the first shadowed region 2110. For example, the processor 160 may identify a region including the plurality of vertical lines and no horizontal line as the first shadowed region 2110.

In addition, the processor 160 may identify a region where the first pattern 2130 is projected and the second pattern 2131 is not projected as the second shadowed region 2120. For example, the processor 160 may identify a region including the plurality of horizontal lines and no vertical line as the second shadowed region 2120.

The external projector 300 may identify the first shadowed region 2110 and the second shadowed region 2120 by using the same method as the electronic device 100.

In addition, the processor 160 may project a portion of the source image that corresponds to the second shadowed region 2120, where the external projector 300 is not capable of projecting the image, onto the projection surface 20.

The external projector 300 may project a portion of the source image that corresponds to the first shadowed region 2110, where the processor 160 is not capable of projecting the image, onto the projection surface 20.

Accordingly, as shown in FIG. 22, the processor 160 and the external projector 300 in conjunction with each other may project the source image 30 onto the projection surface 20 in front of which the object 10 is disposed. Here, the processor 160 and the external projector 300 may project the source image without any shadowed region caused by the object 10.

Meanwhile, the electronic device 100 and the external projector 300 may project the same image together onto the projection surface. Here, as shown in FIG. 20, if the electronic device 100 and the external projector 300 project the image onto the projection surface 20, the image may be projected into the first shadowed region 2010 only by the electronic device 100, and the image may be projected into the second shadowed region 2020 only by the external projector 300. In addition, the image may be projected into the remaining region, excluding the first shadowed region 2010 and the second shadowed region 2020 by the electronic device 100 and the external projector 300 together.

Accordingly, the brightness of the image projected into the first shadowed region 2010 and the second shadowed region 2020 may be lower than the brightness of the image projected into the remaining region excluding the first shadowed region 2010 and the second shadowed region 2020.

In this case, the processor 160 may identify the first shadowed region 2010 by using the same method as described above, and increase the brightness of the image projected into the identified first shadowed region 2010 to thus project the image onto the projection surface 20. In addition, the external projector 300 may identify the second shadowed region 2020, and increase the brightness of the image projected into the identified second shadowed region 2020 to thus project the image onto the projection surface 20.

The processor 160 may project the image having a first brightness into the remaining region of the projection surface 20 that excludes the first shadowed region 2010. In addition, the external projector 300 may project the image having a second brightness into the remaining region of the projection surface 20 that excludes the second shadowed region 2020.

Accordingly, the image having a third brightness, which is the sum of the first brightness and the second brightness, may be projected into the remaining region excluding the first shadowed region 2010 and the second shadowed region 2020.

Here, the processor 160 may project the image having the third brightness into the first shadowed region 2010. In addition, the external projector 300 may project the image having the third brightness into the second shadowed region 2020.

Accordingly, the image having a uniform brightness may be projected onto the projection surface 20. Here, the image having the third brightness may be projected onto the projection surface 20, which includes the first shadowed region 2010 and the second shadowed region 2020.

In the above-described embodiment, the electronic device 100 and the external projector 300 may project the same image, but this is merely an example, and the disclosure is not limited thereto. The processor 160 may project the first image, and the external projector 300 may project a second image. Here, the images respectively projected by the processor 160 and the external projector 300 may be overlapped and displayed on the projection surface 20.

Here, the processor 160 may project a portion of the second image that corresponds to the second shadowed region 2120, where the external projector 300 is not capable of projecting the image, into the second shadowed region 2120. Here, the processor 160 may receive, from the external projector 300, information for projecting a portion of the second image.

The external projector 300 may project a portion of the first image that corresponds to the first shadowed region 2110, where the processor 160 is not capable of projecting the image, into the first shadowed region 2110. Here, the external projector 300 may receive, from the processor 160, information for projecting a portion of the first image.

According to an embodiment of the present disclosure, the processor 160 may extract, within the second image, the second pattern projected by the external projector onto the projection surface. If the second pattern is extracted, the processor 160 may identify the shadowed region caused by the object within the second pattern. In addition, the processor 160 may identify a partial image corresponding to the shadowed region within the third image projected by the external projector onto the projection surface. In addition, the processor 160 may add the identified partial image to a portion of the first image that corresponds to the shadowed region within its remaining region. In addition, the processor 160 may project the first image excluding the distorted pattern region and including the partial image added thereto.

According to an embodiment of the present disclosure, the electronic device 100 and the processor 160 may identify the pose of the object by using the above-described method, and perform various actions by using the identified pose of the object.

The processor 160 may generate an avatar corresponding to the pose of the object by using the identified pose of the object. The processor 160 may add the generated avatar to the first image and project the first image, to which the avatar is added.

The processor 160 may analyze a body type of the object by using the identified pose of the object. For example, the processor 160 may analyze the body type of the object as “slim”, “normal”, and “obese”.

The processor 160 may analyze a motion level of the object by using the identified pose of the object. For example, the processor 160 may analyze the pose of the object as “good”, “medium”, and “bad”.

The processor 160 may guide the pose of the object by using the identified pose of the object. The processor 160 may compare the identified pose of the object with a predetermined pose, and guide the pose of the object for the pose of the object to be closer to the predetermined pose.

Although certain embodiments have been described hereinabove, each embodiment is not necessarily implemented individually, and may also be entirely or partially combined with at least one other embodiment and implemented together in one product.

Meanwhile, the term “˜er/˜or” or “module” used in the present disclosure may include a unit including hardware, software, or firmware, and may be used interchangeably with the term, for example, logic, a logic block, a component, or a circuit. The “˜er/˜or” or “module” may be an integrally formed component, or a minimum unit or part performing one or more functions. For example, the module may include the application-specific integrated circuit (ASIC).

The various embodiments of the present disclosure may be implemented by software including an instruction stored on a machine-readable storage medium (for example, a computer-readable storage medium). A machine may be a device that invokes the stored instruction from the storage medium, may be operated based on the invoked instruction, and may include the electronic device 100 in the disclosed embodiments. If the instruction is executed by the processor, the processor may directly perform a function corresponding to the instruction or other components may perform the function corresponding to the instruction under the control of the processor. The instruction may include the codes generated or executed by the compiler or the interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

According to one or more embodiments, the methods according to the various embodiments disclosed in this document may be included in a computer program product and then provided. The computer program product may be traded as a product between a seller and a purchaser. The computer program product may be distributed in a form of the machine-readable storage medium (for example, a compact disc read only memory (CD-ROM)), or may be distributed online through an application store (for example, PlayStore™). In case of the online distribution, at least portions of the computer program product may be at least temporarily stored in the storage medium such as a memory of a server of a manufacturer, a server of an application store, or a relay server or be temporarily created.

In a non-transitory computer-readable recording medium including a program for executing a control method of a projector, wherein the method includes adding a first pattern to a source image to obtain a first image, and projecting the first image onto a projection surface, acquiring a second image capturing the projection surface, identifying a pattern region distorted by an object disposed in front of the projection surface within the first pattern included in the second image, and projecting the remaining image of the source image, excluding its portion corresponding to the distorted pattern region, onto the projection surface.

Each of the components (for example, modules or programs) according to the various embodiments may include one entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner or a heuristic manner, at least some of the operations may be performed in a different order or be omitted, or other operations may be added.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A control method of an electronic device, the method comprising:
adding a first pattern to a source image to obtain a first image;
projecting the first image onto a projection surface;
acquiring a second image of the first pattern included in the projected first image;
based on the first pattern included in the second image, identifying a pattern region distorted by an object in front of the projection surface; and
changing a color or brightness of a portion of the source image that corresponds to the distorted pattern region.

2. The method as claimed in claim 1, further comprising predicting a pose change of the object based on a change of the pattern region distorted by the object,
wherein the changing the color or brightness comprises changing the color or brightness of a portion of the source image that corresponds to the predicted pose change.

3. The method as claimed in claim 1, further comprising:
extracting a specific region of the object from the second image; and
predicting a position change of the specific region,
wherein the changing the color or brightness comprises changing the color or brightness of a region of the source image that corresponds to the position change of the specific region.

4. The method as claimed in claim 1, wherein the projecting the first image onto the projection surface comprises:
based on an external projector projecting a third image, different from the first image, onto the projection surface, projecting the first image at a position that at least partially overlaps the third image.

5. The method as claimed in claim 4, wherein the first image includes at least one first matching point, and
wherein the first image is projected at a position at which the at least one first matching point overlaps at least one second matching point included in the third image.

6. The method as claimed in claim 1, wherein the changing the color or brightness comprises:
among a plurality of pixels corresponding to a plurality of values, changing a value of a pixel corresponding to the distorted pattern region based on the value being within a predetermined range.

7. The method as claimed in claim 1, wherein the source image includes a plurality of frames, and
wherein the adding the first pattern to the source image comprises:
replacing at least one frame among the plurality of frames with a frame that includes the first pattern.

8. The method as claimed in claim 1, wherein the first pattern includes a plurality of patterns among: a plurality of horizontal lines, a plurality of vertical lines, a plurality of diagonal lines, or a plurality of lines at different angles, and
wherein the adding the first pattern to the first image comprises:
adding the plurality of patterns to the first image in sequence.

9. An electronic device comprising:
a projector;
at least one memory storing instructions, and information about a first pattern; and
at least one processor configured to execute the instructions to:
add the first pattern to a source image to obtain a first image,
control the projector to project the first image onto a projection surface,
acquire a second image of the first pattern included in the projected first image,
based on the first pattern included in the second image, identify a pattern region distorted by an object in front of the projection surface, and
control the projector to change a color or brightness of a portion of the source image that corresponds to the distorted pattern region.

10. The electronic device as claimed in claim 9, wherein the at least one processor is further configured to execute the instructions to:
predict a pose change of the object based on a change of the pattern region distorted by the object, and
control the projector to change the color or brightness of a portion of the source image that corresponds to the predicted pose change

11. The electronic device as claimed in claim 9, wherein the at least one processor is further configured to execute the instructions to:
extract a specific region of the object from the second image,
predict a position change of the specific region, and
control the projector to change the color or brightness of a region of the source image that corresponds to the position change of the specific region.

12. The electronic device as claimed in claim 9, wherein the at least one processor is further configured to control the projector to: based on an external projector projecting a third image, different from the first image, onto the projection surface, project the first image at a position that at least partially overlaps the third image.

13. The electronic device as claimed in claim 12, wherein the first image comprises at least one first matching point, and
wherein the at least one processor is further configured to execute the instructions to: control the projector to project the first image at a position at which the at least one first matching point overlaps at least one second matching point included in the third image.

14. The electronic device as claimed in claim 9, wherein the at least one processor is further configured to execute the instructions to:
among a plurality of pixels corresponding to a plurality of values, change a value of a pixel corresponding to the distorted pattern region based on the value being within a predetermined range.

15. A non-transitory computer-readable recording medium storing a program which, when executed, causes at least one processor to perform a control method of an electronic device, wherein the method comprises:
adding a first pattern to a source image to obtain a first image;
projecting the first image onto a projection surface;
acquiring a second image of the first pattern included in the projected first image;
based on the first pattern included in the second image, identifying a pattern region distorted by an object in front of the projection surface; and
changing a color or brightness of a portion of the source image that corresponds to the distorted pattern region.

16. A control method of an electronic device, the method comprising:
obtaining a source image to be projected;
projecting a first pattern onto a projection surface;
acquiring a second image of the projected first pattern;
based on the first pattern included in the second image, identifying a pattern region distorted by an object in front of the projection surface; and
projecting the source image and the first pattern onto the projection surface, excluding a portion of the source image that corresponds to the distorted pattern region.

17. The control method of claim 16, further comprising:
adding the first pattern to the source image to obtain a first image,
wherein the projecting the source image and the first pattern comprises:
projecting the first image onto the projection surface, and
changing a color or brightness of a portion of the source image that corresponds to the distorted pattern region.

18. The control method of claim 17, wherein the source image includes a plurality of frames, and
wherein the adding the first pattern to the source image comprises:
replacing at least one frame among the plurality of frames with a frame that includes the first pattern.

19. The control method of claim 16, further comprising predicting a pose change of the object based on a change of the pattern region distorted by the object,
wherein the projecting the source image and the first pattern comprises:
projecting the source image and the first pattern onto the projection surface, excluding a portion of the source image that corresponds to the predicted pose change.

20. The control method of claim 16, further comprising:
extracting a specific region of the object from the second image; and
predicting a position change of the specific region,
wherein the projecting the source image and the first pattern comprises:
projecting the source image and the first pattern onto the projection surface, excluding a portion of the source image that corresponds to the position change of the specific region.
